(19) United States
(12) Patent Application Publication
(10) Pub. No.: US 2022/0167673 A1
(43) Pub. Date: Jun. 2, 2022

(54) ELECTRONIC CIGARETTE AND ATOMIZATION DEVICE THEREOF

(71) Applicant: O-NET AUTOMATION TECHNOLOGY (SHENZHEN) LIMITED, Shenzhen (CN)

(72) Inventors: Huihua HUANG, Shenzhen (CN); Meiling GUO, Shenzhen (CN); Aimin MAO, Shenzhen (CN); Bo ZHOU, Shenzhen (CN)

(73) Assignee: O-NET AUTOMATION TECHNOLOGY (SHENZHEN) LIMITED, Shenzhen (CN)

(21) Appl. No.: 17/439,807

(22) PCT Filed: Mar. 20, 2019
(86) PCT No.: PCT/CN2019/078920

§ 371 Date: Sep. 16, 2021

(51) Int. Cl. A24F 40/46; H05B 3/06; A24F 40/44; A24F 40/10; A24F 40/42; A24F 40/48

(52) U.S. Cl. CPC A24F 40/46; H05B 3/06; A24F 40/44; H05B 2203/021; A24F 40/42; A24F 40/48; H05B 2203/016; A24F 40/10

(57) ABSTRACT

An atomization device (10) includes a housing (11), an atomization assembly (12), a liquid conducting body (13), and a base (14). A gas flow channel (10) and a liquid storage compartment (102) that are separated from each other are provided in the housing (11). The atomization assembly (12) includes a main body (121) and a heat generating sheet (122). The main body (121) is mounted on a first end of the housing (11), and the base (14) is mounted on the side of the main body (121) away from the housing (11). The main body (121) is provided with a receiving chamber (120) communicated with the liquid storage compartment (102). The heat generating sheet (122) is disposed on the main body (121) across the receiving chamber (120) and is located in the gas flow channel (101). The liquid conducting body (13) is disposed in the receiving chamber (120) and is in contact with the heat generating sheet (122), so as to conduct cigarette liquid contained in the liquid storage compartment (102) to the heat-generating plate (122).

### FIELD OF THE INVENTION

The present invention relates to the field of electronic cigarettes, and more particularly to an electronic cigarette and an atomization device thereof.

### DESCRIPTION OF THE RELATED ART

In a contemporary electronic cigarette, an atomization assembly includes a heating body and a liquid conducting body. The heating body is attached to the liquid conducting body by means of winding or printing. Atomization assembly of this kind suffers the following disadvantages:

(1) The atomization assembly is subject to constraints imposed by turns or a printing area of the heating body, and thus, the area of atomization is limited and the amount of smoke vapor is small.

(2) The heating body needs two additional conductors to respectively connect to the positive and negative electrodes of an atomization device, and the positive and negative electrodes of the atomization device are then connected to a power supply device, so that in a normal condition, the positive and negative electrodes of the atomization device also provide a function of connection with the power supply device, and consequently, the atomization device is complicated in structure and low in assembling efficiency, this being unfavorable to automatized production.

(3) The liquid conducting body requires, additionally, a support base and a sealing member in order to enable assembling of the atomization device, otherwise the atomization device would suffer potential risk of liquid leaking, this making the structure complicated.

### SUMMARY OF THE INVENTION

The technical issue that the present invention is made to aim to is to provide an atomization device of an electronic cigarette that has an enlarged atomization area and enables mass production, and an electronic cigarette that includes the atomization device.

The technical solution that the present invention adopts to resolve the technical issue is to provide an atomization device of an electronic cigarette, comprising a housing, an atomization assembly, a liquid conducting body, and a base, the housing being formed, in an interior thereof, with a gas flow channel and a liquid storage compartment that are separated from each other;

the atomization assembly comprising a main body and a heat-generating plate, the main body being mounted on a first end of the housing, the base being mounted to one side of the main body that is distant from the housing; the main body is formed with a receiving chamber in communication with the liquid storage compartment, the heat-generating plate being disposed on the main body in a manner of spanning over the receiving chamber and located in the gas flow channel; and the liquid conducting body is disposed in the receiving chamber and in contact with the heat-generating plate to conduct cigarette liquid contained in the liquid storage compartment to the heat-generating plate.

Preferably, the housing is provided, in the interior thereof, with a cylindrical body that extends in an axial direction of the housing, the cylindrical body having an interior channel that forms the liquid storage compartment, a space between the cylindrical body and an inside surface of the housing forming the gas flow channel; and

the main body is fit to an end of the cylindrical body, the heat-generating plate being disposed on a surface of the main body that is opposite to the cylindrical body; the base supports the main body and is tightly fit to the first end of the housing; and the gas flow channel passes between the main body and the base.

Preferably, the electronic cigarette atomization device further comprises a gas flow outlet opening and a gas flow inlet opening in communication with the gas flow channel;

the gas flow outlet opening is formed in a second end of the housing; and

the gas flow inlet opening is formed in the second end of the housing and is opposite to the gas flow outlet opening, or the gas flow inlet opening and the gas flow outlet opening formed in the base to be opposite to each other; or, alternatively, the gas flow inlet opening is formed in a side wall of the housing and/or a side plate of the base.

Preferably, the base comprises a base seat and a side plate connected to the base seat; the base seat is mating engagement with the first end of the housing to close the first end of the housing and being supported at one side of the main body; and the side plate is in tight fitting engagement with an inside surface of the housing.

Preferably, conductors are respectively provided on two ends of the heat-generating plate to be electrically connected with a power supply device of the electronic cigarette, respectively; and the base seat is formed with through troughs penetrating through two surfaces thereof in order to expose the conductors.

Preferably, the housing is provided, in the interior thereof, with a cylindrical body that extends in an axial direction of the housing, the cylindrical body having an internal channel that forms the gas flow channel, a space between the cylindrical body and an inside surface of the housing forming the liquid storage compartment;

the main body is arranged to close and block the first end of the housing and is connected to an end of the cylindrical body, the liquid conducting body being arranged in the receiving chamber to exactly face the gas flow channel, the heat-generating plate being located on one side of the liquid conducting body that faces the cylindrical body; the main body is further formed with a liquid guide channel located in an outer periphery of the receiving chamber, the liquid storage compartment and the liquid guide channel being in communication with each other in order to allow the cigarette liquid contained in the liquid storage compartment to move into the liquid guide channel to be adsorbed by the liquid conducting body located in the receiving chamber; and

a gas flow opening is formed in a second end of the housing to be in communication with the gas flow channel.

Preferably, positioning pillars are provided on one side of the main body that faces the housing to mate with the liquid storage compartment, the positioning pillar being hollowed for communication between the liquid storage compartment and the liquid guide channel.

Preferably, the electronic cigarette atomization device further comprises a sealing seat arranged between the main body and the first end of the housing.

Preferably, the sealing seat is arranged on the main body by having the positioning pillars sleeved therein, and the sealing seat is formed with liquid guiding openings in communication with the positioning pillars, and is provided with a positioning cylinder projecting in a direction toward the cylindrical body, the positioning cylinder being inserted into the end of the cylindrical body to be in tight fitting to the end.

Preferably, conductors are provided on two ends of the heat-generating plate to electrically connect to a power supply device of the electronic cigarette; and the conductors are exposed outside the main body.

The present invention also provides an electronic cigarette, which comprises an atomization device provided in any description above.

In the atomization device according to the present invention, the atomization assembly is provided with a heat-generating plate to serve as a. heat generating body that exhibits an enlarged surface area in contact with a liquid conducting body, in order to achieve atomization through a large surface area; the atomization device includes a reduced number of components, has a good leakproof property, involves a simplified structure, and is good for automatized production and improving manufacturing efficiency.

### BRIEF DESCRIPTION OF THE DRAWINGS

A detailed description will be provided below with reference to the attached drawings and embodiments. In the drawings:

FIG. 1 is an exploded view showing an atomization device according to a first embodiment of the present invention;

FIG. 2 is a cross-sectional view showing the atomization device according to the first embodiment of the present invention;

FIG. 3 is a perspective view showing an atomization assembly of the atomization device according to the first embodiment of the present invention;

FIG. 4 is a perspective view showing a base of the atomization device according to the first embodiment of the present invention;

FIG. 5 is an exploded view showing an atomization device according to a second embodiment of the present invention;

FIG. 6 is an exploded view showing an atomization device according to a third embodiment of the present invention;

FIG. 7 is an exploded view showing an atomization device according to a fourth embodiment of the present invention; and

FIG. 8 is a cross-sectional view showing the atomization device according to the fourth embodiment of the present invention.

### DETAILED DESCRIPTION OF PREFERRED EMBODIMENTS OF THE INVENTION

For better understanding of the technical features, purposes, and efficacy of the present invention, embodiments of the present invention will be described in detail with reference to the drawings.

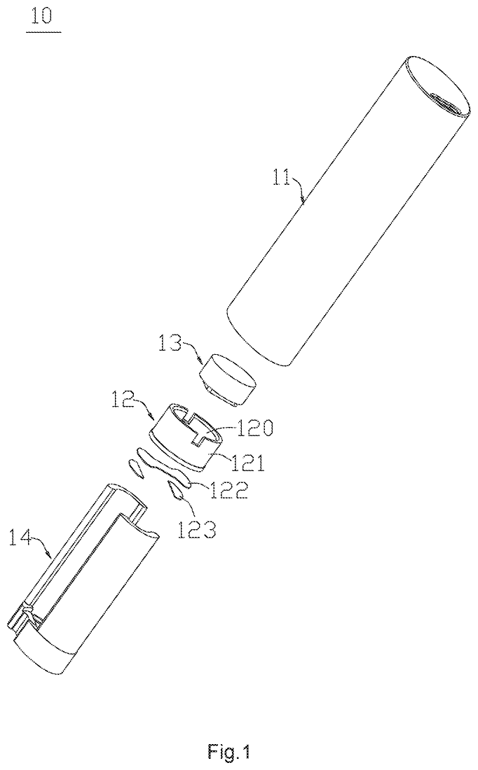

As shown in FIG. 1-3, an electronic cigarette atomization device 10 according to a first embodiment of the present invention comprises a housing 11, an atomization assembly 12, a liquid conducting body 13, and a base 14.

In the device, the housing 11 is provided, in an interior thereof, with a gas flow channel 101 and a liquid storage compartment 102, which are separated from each other and are for discharging of vaporized cigarette liquid and storing of a cigarette liquid, respectively. The housing 11 includes a first end and a second end that are opposite to each other; in the instant embodiment, the housing 11 is of a cylindrical structure that is open at the first end and closed at the opposite second end.

The atomization assembly 12 is mounted on the first end of the housing 11, and the base 14 is mounted on one side of a main body 121 that is distant from the housing 11, such that the two collaborate to close the open first end of the housing 11. The atomization assembly 12 comprises the main body 121 and a heat-generating plate 122. The atomization assembly 12 is mounted, by means of the main body 121, to the first end of the housing 11. The main body 121 may be of a multiple-facet structure or a column like structure for securely fixing and supporting the heat-generating plate 122, and can be made of a high-temperature resistant plastic material that possesses an insulating property and does not melt when the heat-generating plate 122 is supplied with electrical power and generates heat. The heat-generating plate 122 is provided for heating and vaporizing the cigarette liquid, and is of a plate like structure that is different from a heating filament, in order to be set in contact, in a maximum extent, with the liquid conducting body 13 to expand an atomization area. The heat-generating plate 122 can be of a structure of a solid plate or a grating sheet, and can be made of a material of stainless steel, nickel, titanium, nickel-chromium alloy, aluminum, or carbon. An outer peripheral shape of the heat-generating plate 122 can be one of various shape, such as a polygon, an ellipse, and a circle, but not limited thereto. Optionally, the heat-generating plate 122 is fixed on the main body 121 by means of hot pressing or in-mold injection.

The main body 121 is formed with a receiving chamber 120 in communication with the liquid storage compartment 102. The heat-generating plate 122 is disposed on the main body 121, in a manner of spanning across the receiving chamber 120, and is located in the gas flow channel 101. The liquid conducting body 13 is arranged inside the receiving chamber 120 and is set in contact with the heat-generating plate 122 in order to conduct the cigarette liquid contained in the liquid storage compartment 102 toward the heat-generating plate 122. The heat-generating plate 122 is operable to vaporize the cigarette liquid to form cigarette vapor moving along the gas flow channel 101 to discharge out of the housing 11. The liquid conducting body 13 can be a porous structure, such as a piece of liquid conducting cotton.

The base 14 is mounted on one side of the main body 121 that is distant from the housing 11.

Specifically, in the instant embodiment, the housing 11 is provided, in the interior thereof, with a cylindrical body 15 that extends in an axial direction of the housing 11. The cylindrical body 15 has an end that is connected to an internal end surface of the second end of the housing 11 and an opposite end that is open. The cylindrical body 15 has an internal channel that forms the liquid storage compartment 102. A space between the cylindrical body 15 and an inside surface of the housing 11 forms the gas flow channel 101.

The main body 121 of the atomization assembly 12 is mounted to the end of the cylindrical body 15 by means of force fitting, so as to block the open end of the cylindrical body 15. The main body 121 has an outer peripheral shape that is arranged to correspond to the cylindrical body 15. The receiving chamber 120 of the main body 121 penetrates through two opposite surfaces of the main body 121 and is thus in communication with the liquid storage compartment 102. The liquid conducting body 13 is set in liquid-conducting connection with the liquid storage compartment 102. The heat-generating plate 122 is disposed on a surface of the main body 121 that is opposite to the cylindrical body 15, so as to span over one side of the receiving chamber 120 and be in contact with the liquid conducting body 13. Two ends of the heat-generating plate 122 are respectively provided with conductors 123, which correspond to a positive electrode and a negative electrode, respectively, for connection with a power supply device of the electronic cigarette.

The conductors 123 are set to cover and connected to the end portions of the heat-generating plate 122, or are alternatively set in direct connection with the ends of the heat-generating plate 122. The conductors 123 are made of a metallic material, which can be the same material as that making the heat-generating plate 122, and can be alternatively formed, in an integrated form, with the heat-generating plate 122 by means of electroplating, brush plating, or stamping.

The base 14 supports the main body 121 and is set in tight fitting with the first end of the housing 11. The gas flow channel 101 is arranged to pass between the main body 121 and the base 14. An outer peripheral shape of the base 14 is arranged to correspond to an outer peripheral shape of the housing 11.

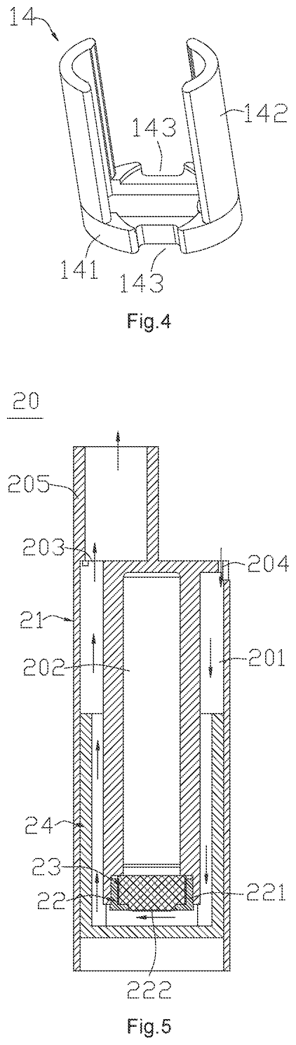

In the instant embodiment, as shown in FIG. 4, the base 14 comprises a base seat 141 and a side plate 142 connected to the base seat 141. The side plate 142 can be arranged as two pieces, as shown in FIG. 4, or can alternatively be one single annular plate corresponding to an outer circumference of the base seat 141. The base seat 141 mates the first end of the housing 11 to close the first end of the housing 11 and is supported at one side of the main body 121; the side plate 142 is set in tight fitting engagement with the inside surface of the housing 11.

Optionally, the cylindrical body 15 has an axial length that is smaller than an axial length of the housing 11, so that the cylindrical body 15 is entirely located in the interior of the housing 11. The main body 121 is mounted inside the housing 11 to close and block the end of the cylindrical body 15. The base 14 can also be entirely located in the interior of the housing 11, and the base seat 141 is adjacent to and supported below the main body 121, the side plate 142 being in tight fitting to the inside surface of the housing 11 to fix the base 14 to the housing 11.

The base seat 141 of the base 14 is formed with through troughs 143 that penetrate through two opposite surfaces thereof in order to expose the conductors 123. With the first end of the housing 11 being set as a bottom, the conductors 123 on the two ends of the heat-generating plate 122 can be exposed through the through troughs 143 to the bottom of the housing 11, namely being exposed on a bottom of the entire atomization device to ease direct electrical connection with positive and negative electrodes of the power supply device of the electronic cigarette.

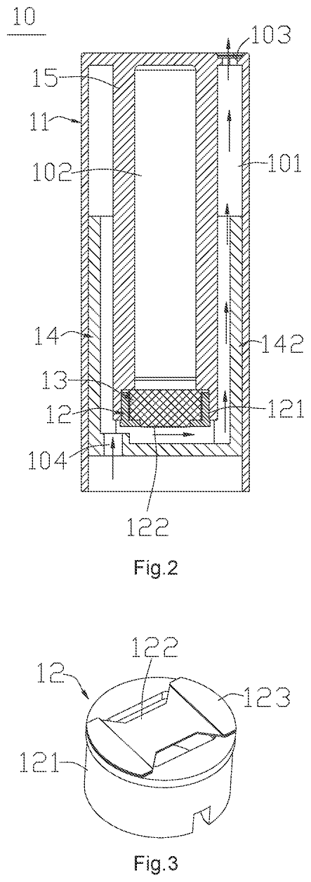

Further, the electronic cigarette atomization device according to the present invention further comprises a gas flow outlet opening 103 and a gas flow inlet opening 104 in communication with the gas flow channel 101. As shown in FIG. 2, in the instant embodiment, the gas flow outlet opening 103 is arranged in the second end of the housing 11. The gas flow inlet opening 104 is arranged in the base 14 to be opposite to the gas flow outlet opening 103, and is specifically arranged in the base seat 141 of the base 14, so that the atomization device of the instant embodiment takes in air from the bottom for efficiently bringing away the cigarette vapor vaporized by the heat-generating plate 122. A gas flow is moving in a direction indicated by arrows shown in FIG. 2 for moving, after entry at the gas flow inlet opening 103, along the gas flow channel 301 to pass, in sequence, between the main body 121 and the base 14, between the side plate 142 and the cylindrical body 15, and between the inside surface of the housing 11 and the cylindrical body 15 to thereafter flow out of the gas flow outlet opening 103.

As shown in FIG. 5, an electronic cigarette atomization device 20 according to a second embodiment of the present invention comprises a housing 21, an atomization assembly 22, a liquid conducting body 23, and a base 24.

In the device, the housing 21 is provided, in an interior thereof, with a gas flow channel 201 and a liquid storage compartment 202, which are separated from each other and are for discharging of vaporized cigarette liquid and storing of a cigarette liquid, respectively. The atomization assembly 22 comprises a main body 221 and a heat-generating plate 222. The main body 221 is mounted to a first end of the housing 21, and the base 24 is mounted to one side of the main body 221 that is distant from the housing 21. The main body 221 is formed with a receiving chamber in communication with the liquid storage compartment 202. The heat-generating plate 222 is disposed on the main body 221, in a manner of spanning over the receiving chamber, and is located in the gas flow channel 201; the liquid conducting body 23 is disposed in an interior of the receiving chamber and is in contact with the heat-generating plate 222 in order to conduct the cigarette liquid contained in the liquid storage compartment 202 toward the heat-generating plate 222.

Specific arrangements of and relationships among the housing 21, the atomization assembly 22, the liquid conducting body 23, and the base 24 may be referred to the description of the first embodiment provided above, and repeated description will be omitted herein.

In the instant embodiment, a gas flow outlet opening 203 and a gas flow inlet opening 204 that are in communication with the gas flow channel 201 are both arranged in the second end of the housing 11, and the two are spaced from and opposite to each other; as indicated by arrows shown in FIG. 5, a gas flow gets entry, through the gas flow inlet opening 204, into the gas flow channel 201 and passes over the heat-generating plate 222 to bring cigarette vapor that is heated and vaporized by the heat-generating plate 222 toward the gas flow outlet opening 203.

The gas flow outlet opening 203 and the gas flow inlet opening 204 are arranged at the same end of the housing 11, so that the two are oriented identically. In use, as being combined with an electronic cigarette, the portion where the gas flow outlet opening 203 is located serves as a top for inhalation by the user. The gas flow inlet opening 204 is also located at the top, and this, compared to disposition at the bottom, would effectively prevent liquid leaking.

Further, in the instant embodiment, for distinction between the gas flow inlet opening 204 and the gas flow outlet opening 203, an end surface of the second end of the housing 11 is provided with an inhaling mouth 205 that surrounds and is in combination with the gas flow outlet opening 203. The inhaling mouth 205 is in communication with the gas flow outlet opening 203.

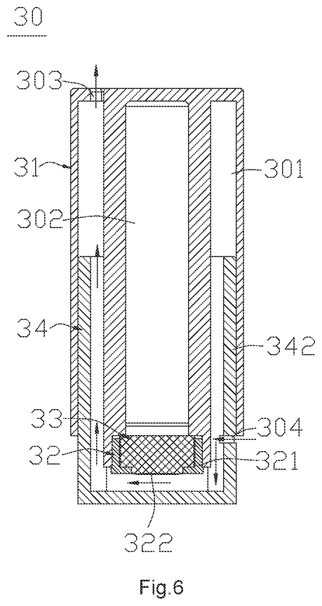

As shown in FIG. 6, an electronic cigarette atomization device 30 according to a third embodiment of the present invention comprises a housing 31, an atomization assembly 32, a liquid conducting body 33, and a base 34.

In the device, the housing 31 is provided, in an interior thereof, with a gas flow channel 301 and a liquid storage compartment 302, which are separated from each other and are for discharging of vaporized cigarette liquid and storing of a cigarette liquid, respectively. The atomization assembly 32 comprises a main body 321 and a heat-generating plate 323. The main body 321 is mounted to a first end of the housing 31, and the base 34 is mounted to one side of the main body 321 that is distant from the housing 31. The main body 321 is formed with a receiving chamber in communication with the liquid storage compartment 302. The heat-generating plate 323 is disposed on the main body 321, in a manner of spanning over the receiving chamber, and is located in gas flow channel 301; the liquid conducting body 33 is disposed in an interior of the receiving chamber and is in contact with the heat-generating plate 323 in order to conduct the cigarette liquid contained in the liquid storage compartment 302 toward the heat-generating plate 323.

Specific arrangements of and relationships among the housing 31, the atomization assembly 32, the liquid conducting body 33, and the base 34 may be referred to the description of the first embodiment provided above, and repeated description will be omitted herein.

In the instant embodiment, a gas flow outlet opening 303 that is in communication with the gas flow channel 301 is arranged in the second end of the housing 31, and a gas flow inlet opening 304 is arranged in a side surface of the atomization device. Specifically, the gas flow inlet opening 304 is formed in a side wall of the housing 31 and/or a side plater 342 of the base 34 to be in communication with the gas flow channel 301 for achieving middle air take-in for the atomization device (gas flowing direction being indicated by arrows shown in FIG. 6), so that while ensuring effective prevention of liquid leaking, effective foolproofness is achieved for preventing a user, during vaping, from accidentally suffocating or incapability of vaping due to mouth holding a gas inlet opening of a top air take-in arrangement.

Optionally, as shown in FIG. 6, a base seat 341 of the base 34 can be located outside the first end of the housing 31, and force fitting of the side plate 342 to an inside surface of the housing 31 securely fixes the entire base 34 to the first end of the housing 31. For the arrangement illustrated above, the gas flow inlet opening 304 can be arranged in the side plate 342 located outside the housing 31, or can alternatively be arranged in a side wall of the housing 31 or penetrating through a side wall of the housing 31 and the side plate 342.

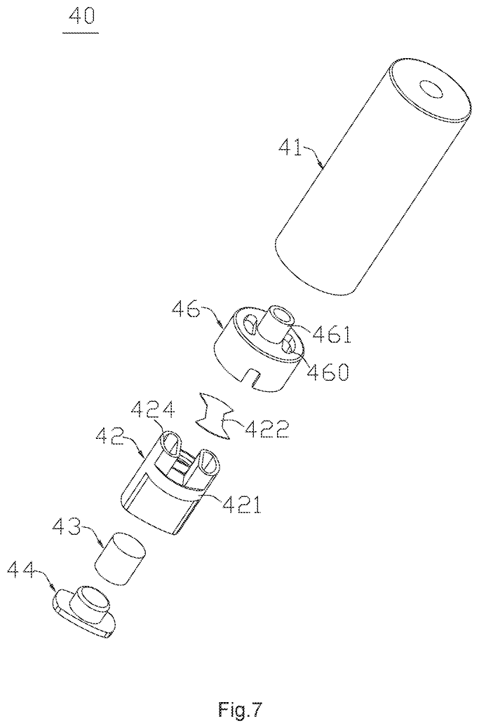

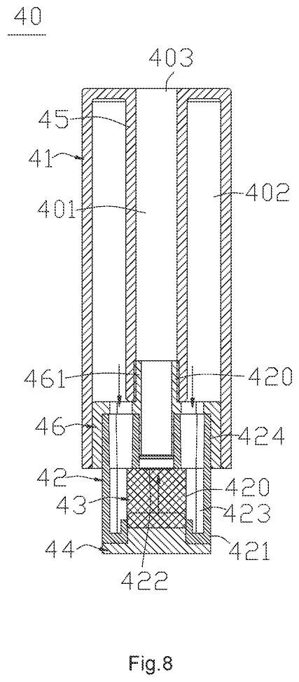

As shown in FIGS. 7 and 8, an electronic cigarette atomization device 40 according to a fourth embodiment of the present invention comprises a housing 41, an atomization assembly 42, a liquid conducting body 43, and a base 44.

In the device, the housing 41 is provided, in an interior thereof, with a gas flow channel 401 and a liquid storage compartment 402, which are separated from each other and are for discharging of vaporized cigarette liquid and storing of a cigarette liquid, respectively. The atomization assembly 42 comprises a main body 421 and a heat-generating plate 423. The main body 421 is mounted on a first end of the housing 41, and the base 44 is mounted to one side of the main body 421 that is distant from the housing 41. The main body 421 is formed with a receiving chamber 420 in communication with the liquid storage compartment 402. The heat-generating plate 423 is disposed on the main body 421, in a manner of spanning over the receiving chamber 420, and is located in the gas flow channel 401; the liquid conducting body 43 is disposed inside the receiving chamber 420 and is in contact with the heat-generating plate 423 in order to conduct the cigarette liquid contained in the liquid storage compartment 402 toward the heat-generating plate 423.

In the instant embodiment, the housing 41 is of a cylindrical structure that is open at the first end and closed at an opposite, second end.

The housing 41 is provided, in the interior thereof, with a cylindrical body 45 that extends in an axial direction of the housing 41. The cylindrical body 45 has an end that is connected to an internal end surface of the second end of the housing 41 and an opposite end that is open. The cylindrical body 45 has an internal channel that forms the gas flow channel 401, and a space between the cylindrical body 45 and an inside surface of the housing 41 forms the liquid storage compartment 402. A gas flow opening 403 is formed in the second end of the housing 41 and is in communication with the gas flow channel 401 to serve as a gas inlet/outlet opening.

The main body 421 of the atomization assembly 42 closes and blocks the first end of the housing 41 and is connected to an end of the cylindrical body 45. The liquid conducting body 43 is arranged in the receiving chamber 420 to exactly face the gas flow channel 401. The heat-generating plate 422 is located on one side of the liquid conducting body 43 that faces the cylindrical body 45. Taking the direction in which the atomization device is positioned in FIG. 8 as an example, the heat-generating plate 422 is located above the liquid conducting body 43, and the gas flow channel 401 is locate above the heat-generating plate 422, so as to allow the heat-generating plate 422 to vaporize cigarette liquid condensed in the gas flow channel 401 for resources saving purposes.

The main body 421 may be of a multiple-facet structure or a column like structure for securely fixing and supporting the heat-generating plate 422 and can be made of a high-temperature resistant plastic material that possesses an insulating property and does not melt when the heat-generating plate 422 is supplied with electrical power and generates heat. The heat-generating plate 422 is provided for heating and vaporizing the cigarette liquid, and is of a plate like structure that is different from a heating filament, in order to be set in contact, in a maximum extent, with the liquid conducting body 43 to expand an atomization area. The heat-generating plate 422 can be of a structure of a solid plate or a grating sheet, and can be made of a material of stainless steel, nickel, titanium, nickel-chromium alloy, aluminum, or carbon. An outer peripheral shape of the heat-generating plate 422 can be one of various shape, such as a polygon, an ellipse, and a circle, but not limited thereto. Optionally, the heat-generating plate 422 is fixed on the main body 421 by means of hot pressing or in-mold injection.

The receiving chamber 420 of the main body 421 penetrates through two opposite surfaces of the main body 421. The heat-generating plate 422 is disposed on a surface of the main body 421 that faces the cylindrical body 45 and spans over the receiving chamber 420. The base 44 is set on an opposite surface of the main body 421 to close an opening the receiving chamber 420 in such a surface.

Two ends of the heat-generating plate 422 are respectively provided with conductors (not shown) to respectively correspond to a positive electrode and a negative electrode for electrical connection with a power supply device of the electronic cigarette. The conductors are exposed outside the main body 421 to ease electrical connection with the power supply device; the main body 421 can be formed with structures like through troughs for easily exposing the conductors. The conductors can be set to cover and connected to the ends of the heat-generating plate 422, or can be alternatively set in direct connection with the ends of the heat-generating plate 422. The conductors are made of a metallic material, which can be the same material as that making the heat-generating plate 422, and can further be alternatively formed, in an integrated form, with the heat-generating plate 122 by means of electroplating, brush plating, or stamping.

The main body 421 is further formed with a liquid guide channel 423 located in an outer periphery of the receiving chamber 420 and in communication therewith. The liquid storage compartment 402 and the liquid guide channel 423 are in communication with each other in order to allow the cigarette liquid contained in the liquid storage compartment 402 to move into the liquid guide channel 423 to be adsorbed by the liquid conducting body 43 located in the receiving chamber 420 (as indicated by the arrows shown in FIG. 8) to be then heated and vaporized by the heat-generating plate 422 for subsequently discharging out through the gas flow channel 401 and the gas flow opening 403.

Further, positioning pillars 424 are provided on one side of the main body 421 that faces the housing 11 to mate the liquid storage compartment 402. The positioning pillars 424 are hollowed for communication with the liquid storage compartment 402 and the liquid guide channel 423. In the instant embodiment, two such positioning pillar 424 are provide and are spaced from each other on the main body 421. An opening that is formed by the receiving chamber 420 penetrating through the surface of the main body 421 facing the cylindrical body 45 is located between the two positioning pillars 424 and is facing and in communication with the gas flow channel 401. An end of the cylindrical body 45 can be corresponding to and supported between the two positioning pillars 424, as being abutting end faces of side walls of the positioning pillar 424.

Further, the electronic cigarette atomization device of the instant embodiment further comprises a sealing seat 46, which is arranged between the main body 421 and the first end of the housing 41.

The sealing seat 46 is arranged on the main body 421 by having the positioning pillars 424 sleeved therein. The sealing seat 46 is of a cylindrical structure having one end that is open and one end that is closed, with the open end fit to the main body 421. The positioning pillars 424 are set, at an end thereof, to abut and contact an internal end surface of the closed end of the sealing seat 46, and side surfaces of the positioning pillars 424 are in abutting engagement with an inside surface of the sealing seat 46. The sealing seat 46 is in mating engagement with the end of the cylindrical body 46 by means of the ends thereof, and an outer peripheral surface of the sealing seat 46 abuts the inside surface of the housing 41.

The sealing seat 46 is formed with liquid guiding openings 460 at locations corresponding to the positioning pillars 424. The liquid guiding openings 460 are in communication with the positioning pillars 424, so that the cigarette liquid contained in the liquid storage compartment 402 may pass through the liquid guiding openings 460 and the positioning pillars 424 to flow into the liquid guide channel 423. The sealing seat 46 is further provided with a positioning cylinder 461 projecting in a direction toward the cylindrical body 45. The positioning cylinder 461 is inserted into and connected with the end of the cylindrical body 45 to be in tight fitting to the end. The main body 421, the sealing seat 46, and the housing 41 are set, sequentially, in tight fitting to each other so as to achieve combination of the three as one piece.

To assemble the atomization device, the atomization assembly and the base are sequentially mounted to the housing. The operation is simple and can be manufactured in an automatic manner with high efficiency.

The electronic cigarette according to the present invention includes the atomization device of any one of the above-described embodiments and may further include a power supply device with the atomization device being connected to the power supply device. The conductors contained in the atomization device are connected, through conductor wires or direct contact, to the positive and negative electrodes of the power supply device to provide electrical connection between the two. The electronic cigarette provides an enlarged amount of cigarette vapor to enhance the user's experience of use.

The description provided above relates to only some embodiments of the present invention and is not intended to limit the scope of the claims of the invention. Equivalent structures or equivalent conversions of process that are made according to the contents of the disclosure and attached drawings or are directly or indirectly used in related technical fields are similarly included in the scope of the claims of the invention.

1. An atomization device of an electronic cigarette, comprising a housing, an atomization assembly, a liquid conducting body, and a base, the housing being formed, in an interior thereof, with a gas flow channel and a liquid storage compartment that are separated from each other;
wherein the atomization assembly comprises a main body and a heat-generating plate, the main body being mounted on a first end of the housing, the base being mounted to one side of the main body that is distant from the housing; the main body is formed with a receiving chamber in communication with the liquid storage compartment, the heat-generating plate being disposed on the main body in a manner of spanning over the receiving chamber and located in the gas flow channel; and the liquid conducting body is disposed in the receiving chamber and in contact with the heat-generating plate to conduct cigarette liquid contained in the liquid storage compartment to the heat-generating plate.

2. The atomization device according to claim 1, wherein the housing is provided, in the interior thereof, with a cylindrical body that extends in an axial direction of the housing, the cylindrical body having an interior channel that forms the liquid storage compartment, a space between the cylindrical body and an inside surface of the housing forming the gas flow channel; and
the main body is fit to an end of the cylindrical body, the heat-generating plate being disposed on a surface of the main body that is opposite to the cylindrical body; the base supports the main body and is tightly fit to the first end of the housing; and the gas flow channel passes between the main body and the base.

3. The atomization device according to claim 2, wherein the electronic cigarette atomization device further comprises a gas flow outlet opening and a gas flow inlet opening in communication with the gas flow channel;
the gas flow outlet opening is disposed in a second end of the housing.

4. The atomization device according to claim 2, wherein the base comprises a base seat and a side plate connected to the base seat; the base seat is mating engagement with the first end of the housing to close the first end of the housing and being supported at a side of the main body; and the side plate is in tight fitting engagement with an inside surface of the housing.

5. The atomization device according to claim 4, wherein conductors are respectively provided on two ends of the heat-generating plate to be electrically connected with a power supply device of the electronic cigarette, respectively; and the base seat is formed with through troughs penetrating through two opposite surfaces thereof in order to expose the conductors.

6. The atomization device according to claim 1, wherein the housing is provided, in the interior thereof, with a cylindrical body that extends in an axial direction of the housing, the cylindrical body having an internal channel that forms the gas flow channel, a space between the cylindrical body and an inside surface of the housing forming the liquid storage compartment;
the main body is arranged to close and block the first end of the housing and is connected to an end of the cylindrical body, the liquid conducting body being arranged in the receiving chamber to exactly face the gas flow channel, the heat-generating plate being located on one side of the liquid conducting body that faces the cylindrical body; the main body is further formed with a liquid guide channel located in an outer periphery of the receiving chamber, the liquid storage compartment and the liquid guide channel being in communication with each other in order to allow the cigarette liquid contained in the liquid storage compartment to move into the liquid guide channel to be adsorbed by the liquid conducting body located in the receiving chamber; and
a gas flow opening is formed in a second end of the housing to be in communication with the gas flow channel.

7. The atomization device according to claim 6, wherein positioning pillars are provided on one side of the main body that faces the housing to mate with the liquid storage compartment, the positioning pillar being hollowed for communication between the liquid storage compartment and the liquid guide channel.

8. The atomization device according to claim 7, wherein the atomization device further comprises a sealing seat arranged between the main body and the first end of the housing; and
the sealing seat is arranged on the main body by having the positioning pillars sleeved therein, and the sealing seat is formed with liquid guiding openings in communication with the positioning pillars, and is provided with a positioning cylinder projecting in a direction toward the cylindrical body, the positioning cylinder being inserted into the end of the cylindrical body to be in tight fitting to the end.

9. The atomization device according to claim 6, wherein conductors are provided on two ends of the heat-generating plate to electrically connect to a power supply device of the electronic cigarette; and the conductors are exposed outside the main body.

10. An electronic cigarette, comprising the atomization device according to claim 1.

11. The atomization device according to claim 3, wherein the gas flow inlet opening is disposed in the second end of the housing and is opposite to the gas flow outlet opening.

12. The atomization device according to claim 3, wherein the gas flow inlet opening is arranged in the base to be opposite to the gas flow outlet opening.

13. The atomization device according to claim 3, wherein the gas flow inlet opening is disposed in a side wall of the housing or a side plate of the base.

14. The atomization device according to claim 3, wherein the gas flow inlet opening is disposed in a side wall of the housing and a side plate of the base.
